(19) United States
(12) Patent Application Publication
(10) Pub. No.: US 2010/0006133 A1
(43) Pub. Date: Jan. 14, 2010

(54) Solar irradiance inductive expeller

(76) Inventor: Bereli M. Lazar, San Francisco, CA (US)

Correspondence Address: BERELI M. LAZAR, 1590 BROADWAY, APT. 410S, SAN FRANCISCO, CA, 94109, US

(21) Appl. No.: 12/287,428

(22) Filed: Oct. 10, 2008

Related U.S. Application Data
(60) Provisional application No. 61/134,794, filed on Jul. 14, 2008.

(51) Int. Cl. H02N 6/00

(52) U.S. Cl. 136/243

(57) ABSTRACT

A Solar Irradiance Inductive Expeller for electro-dynamic radiant energy extracting, comprises an aggregated electro-magnetic structure and a technological method including:
pulse-exciting coils, combined air ionizers,
electrode non-magnetic structure, and combined transducers,
multi-horn tuned receiving antennas, energy and control units,
orientation devices, solenoid servos, frame elements.

The Expeller operates multiple jolt-electro-inductive obtaining of solar energy carried by visible and near infrared spectra with efficiency up to 60% and more in prospective. The base sets placed inside closed cases, panel of sets, tracking module provide effective multiple treatment to the refracted and reflected beams of irradiance by oscillating electro-magnetic fluxes into several ionized zones of said cases.

The estimate average energy ratio of electro-dynamic Expeller to static conventional Photovoltaic systems takes to 7.4.

### RELATED APPLICATION

PPA No. 61/134,794, filed Jul. 14, 2008 by present author.

### FEDERALLY SPONSORED RESEARCH

Not applicable.

### SEQUENCE LISTING OR PROGRAM

Not applicable.

### BACKGROUND OF THE INVENTION

This proposal relates to devices for solar radiation energy transfer and obtaining. The proposal deals with electromagnetic waves, inductive coils interactions, air ionizing, electric and magnetic energy portions carried by visible and near-infrared spectra of solar irradiance.

The conventional structures of solar radiation energy usage are the photovoltaic (PV) systems based on static semiconductor technology. After about 50 years of developing, PV-systems could have reached real average efficiency only from 6% (films) to 12% (silicon cells).

PV-systems can suggest about 0.12 kw/m² of the average 1.0 kw/m² coming to the Earth surface, i.e. only 12%. It looks unacceptable now.

My proposal offers an Inductive Expeller and a method, which include:
dynamic electromagnetic multiple treatments of the irradiance by base sets placed in closed cases with combined air ionizing inside said cases,
pulse-inductive operations with electric and magnetic portions of solar radiation energy, carried by wave lengths 0.35 μm to 1.25 μm,
a multi-horn tuned receiving antenna,
induced electric energy collectors; induced magnetic energy transducers,
combined orientation devices; energy self-supply and output blocks.

The efficiency of this jolt-inductive technological method can be provided up to 60% and more in prospective.

Some patented Prior Arts are represented in the class 250 “Radiant energy” of the US classification system:
a) U.S. Pat. No. 6,452,190 B1 “Radiation detector” by H. Bolk and K. Bethke; includes an absorption chamber and a plurality of avalanche chambers filled with conducting gas;
b) U.S. Pat. No. 6,448,561 B1 “Photoelectric . . . apparatus” by N. Kaifu;
c) U.S. Pat. No. 4,213,797 “Radiant energy . . . converter” by A. Sher;
d) U.S. Pat. No. 4,095,118 “Solar-MHD energy conversion system by K. Ruthbun, with ionizing working fluids and heat-exchangers;
e) U.S. Pat. No. 2,425,102 “Radiant energy receiver” by G. Larson;
f) U.S. Pat. No. 7,053,576 B2 “Energy conversion systems’ by P. and A. Correa with plasma reactors, Tesla coils, and water filled chambers.

A relatively new prior art is a device developed by SUNGRY company, USA. This is XCPV, an ‘Xtreme’ concentrated photovoltaic transducer with better promised efficiency.

Said above prior arts are based on static technological solutions without dynamic magneto-electrical pulse-inductive treatment. The real efficiencies of said solutions can only be at the low levels, similar to regular well known photovoltaic systems. The static semiconductor technologies, applied to solar energy obtaining, look definitely non-prospective.

### BRIEF SUMMARY OF THE INVENTION

The objects of this proposal:
a) to develop a dynamic inductive method and means for energy extracting from solar radiation in the most power carrying visible and infrared spectra at wave lengths from 0.35 μm to 1.25 μm,
b) to provide usage of pulse-electromagnetic devices with combined air-ionizing and induced electric currents collectors, and induced magnetic fluxes combined transducers—all instead of ineffective PV-elements in order to rise the average efficiency from 12% up to 60% and more in prospective,
c) to use a multi-horn tuned receiving antenna for said spectra of solar radiation,
d) to develop base jolt-electromagnetic sets arranged into panels, with angle-orientation devices and electric energy blocks.

The nature and substance of the Solar Irradiance Inductive Expeller are:
a) the base sets with electromagnetic exciting, loosely winded, pulse-inductors, electrode-structure for induced electric currents collecting, electromagnetic multi-coil transducers for induced magnetic fluxes accumulating,
b) the air volumes of said sets, placed inside closed cases, are provided with combined ionizing structures including electrostatic pulse-ionizers and seeding conducting pulse-suspended metallic grit-powder,
c) panels of said sets with multi-horn antennas, tuned for visible light (VL) and near infrared (NIR) spectra; combined orientation system which operates corresponding sun-angles during the day long; energy blocks,
d) a technological method which provides multiple energy jolt-expelling from refracted and reflected beams of VL and NIR radiation inside set cases by pulse-inductive operations in ionized zones of said cases,
e) said method and means conduct the treating of induced electric currents and induced magnetic fluxes separately: in electrode-plate collectors, and in multi-coil electro-magnetic transducers, respectively.

### DRAWING FIGURES

In the drawings, closely related units and elements have the same numerals but different alphabetic suffixes. Numbers of views and sections correspond to the numbers of figures where they are shown.

FIG. 1 shows a side view with partial exposures of a base set of the Expeller.

FIG. 2 illustrates a plan view taken in FIG. 1.

FIG. 3 is a section view taken in FIG. 1 and turned to horizontal.

FIG. 4 shows a side view of an exemplary panel-module unit.

FIG. 5 is a plan view taken in FIG. 4.

FIG. 6 is a scanned technological electric scheme of the base set.

FIG. 7 is a scanned electric scheme of the panel-module shown in FIGS. 4 and 5.

FIGS. 8 and 8A illustrate jolt-inductive interactions in the middle and side zones of any base set operating in the same instant; sections are taken in FIG. 1.

FIGS. 9 and 9A show prospective views of multi-coil transducers operating in the same instant with induced magnetic fluxes in the side and middle zones of any set, respectively.

FIGS. 10 and 11 show a cross-section and a view taken in FIG. 4, respectively.

FIGS. 12, 13, 14 are partial sections taken in FIGS. 5, 2, 2, respectively.

FIG. 15 is a graph-curve illustrating the operative spectral energy areas of the Expeller and PV-systems in spectral comparison.

FIG. 16 is a comparative table chart of the basic average energy data related to PV-systems and present Expeller.

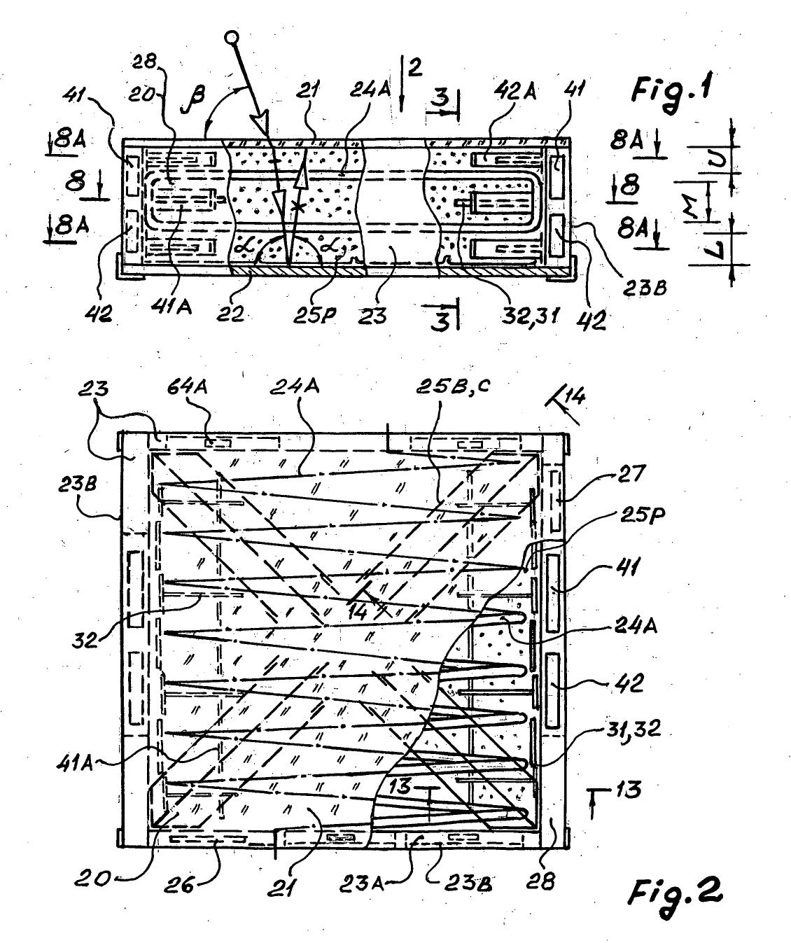

### REFERENCE NUMERALS AND SYMBOLS

20—base set 20A,B,C,D,E,F—sets arranged into a panel 21—upper screen 22—bottom 23—wall 23A—cooling window unit 23B—wall shield 24—exciting LC-oscillator 24A—exciting inductor 25—ionizing LC-oscillator 25A—ionizing anchor 25B—electrostatic ionizer 25C—needle 25P—seed grit-powder 25S—seed grit-powder dish 26—set supply unit 27—set output unit 28—closed case 30—electrode block 31—electrode plate 32—nonmagnetic rod 40—magnetic transducers block 41—middle zone transducer 41A—middle tab unit 41B—middle tab coil 41C—middle core-casing 41D—start coil 41E—middle output coil 41F—core 42—side zones transducer 42A—side tab unit 42B—side tab coil 42C—side core-casing 42D—start coil 42E—side output coil 42F—core 50—panel 51—multi-horn antenna 51A—antenna circuit 52—tuned trap-dipole 53A,B—panel energy and control units 60—module 61—upper frame 62—static frame 63—hinge unit 64A,B,C—solenoid servos 65—screw unit 66—flange unit 70; C—capacitor 71; L—inductor 72; R—resistor 73—rectifier 74—diode 75—electric battery and charger 76—transformer
Solar radiation: [symbol] incident; [symbol] refracted; [symbol] reflected; [symbol] exciting electromagnetic flux, [symbol] induced magnetic flux, [symbol] induced electric current, a₁, a₂—core air gaps. U, M, L—ionized air zones of the set 20; ζ, β, γ, δ_{1,2}—angles.
Input energy: [symbol] —for exciting inductors transducers' coils; [symbol] —for ionizers.
Output induced energy: Vₑ,o—electrodes' portion; Vₘ0—transducers' portion. —— Wiring [symbol] wire connections [symbol] —transparent screen. Wᵢᵣ—average irradiance, [symbol] —suspended seeding grit-powder.

Reference numerals 23,25C,61,62,63,64A,B, 65,66,70,71,72,73,74,75,76 are universal conventional units and elements, all used in this new proposal.

### DETAILED DESCRIPTION OF THE INVENTION

FIGS. 1,2,3 illustrate how the base set 20 is developed. Are shown:
upper screen 21 made of glass or equally of other materials which are transparent and low-reflective for energy, carrying by VL and NIR spectra of incident solar radiation; case 28,
bottom 22, walls 23 with cooling window units 21A, shields 23B, exciting inductor 24A which is a loosely winded rectangular coil,
ionizers' structure 25 A,B,C,P,S, set supply and output units 26,27, respectively
induced electric currents electrodes' structure 31,32,
induced magnetic fluxes transducers' structure 41,41A,42,42A,
cooling windows servos 64A, ionized air zones U,M,L, beam angles ζ, β.

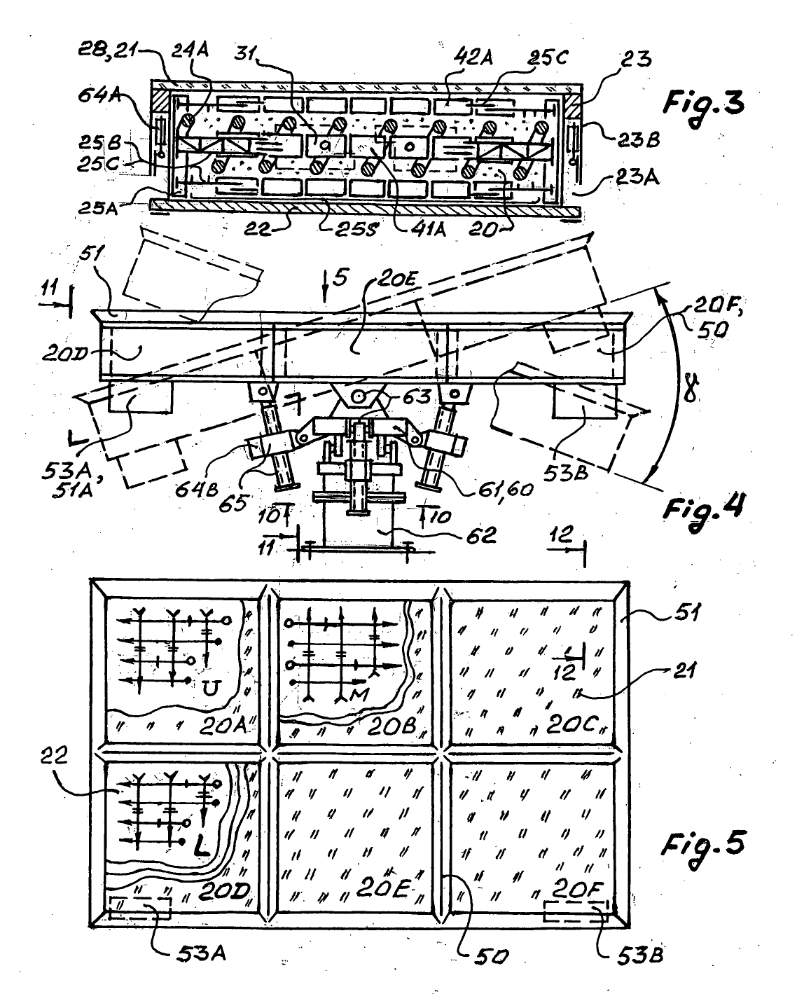

FIGS. 4,5, 10,11 illustrate how the panel 50 and module 60 are developed in present proposal. Are shown:
base sets 20A,B,C,D,E,F, multi-horn antenna 51 with units 51A and 53A,B,
module frame structure 60, 61, 62, 63, 64, 65, 66; angles γ, δ_{1,2};
electro-inductive interactions illustrated in FIG. 5 under screen 21 inside ionized air zones U, M, L, operating in the same instant into any of zones.

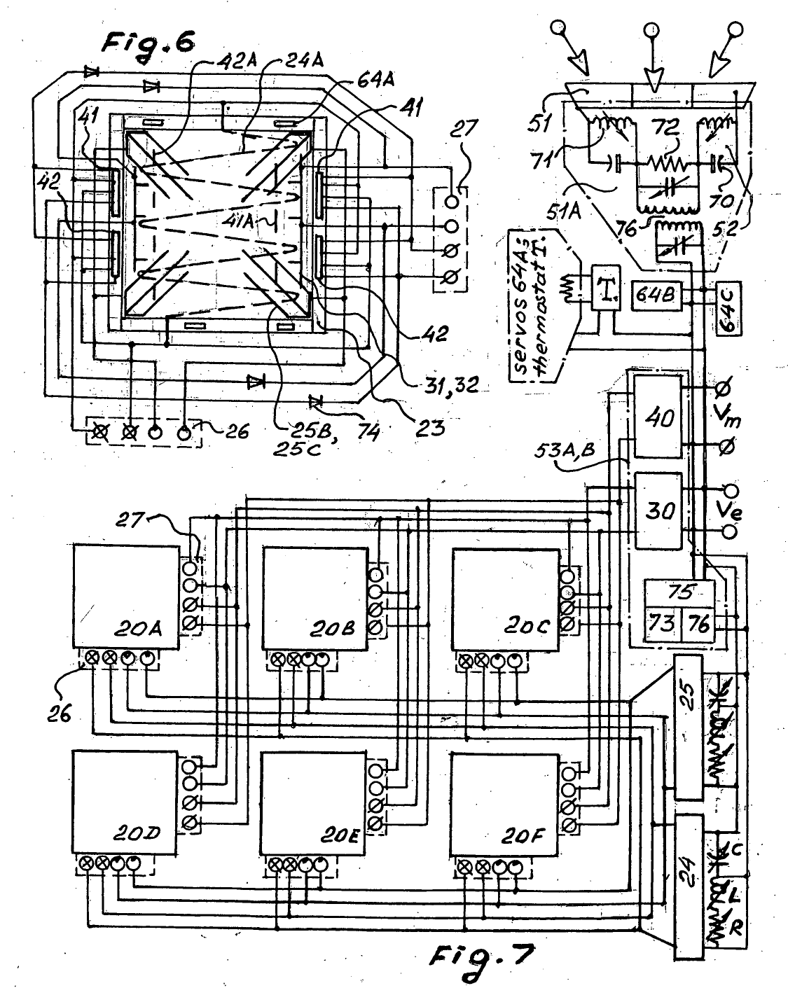

FIGS. 6 and 7 show the electro-technological communications; in addition to said above elements, are illustrated:
the basic electrical circuits, oscillators 24, 25, output units 30, 40,
electrical units 70,71,72,73,74,75,76; output voltages Vₑ, Vₘ.

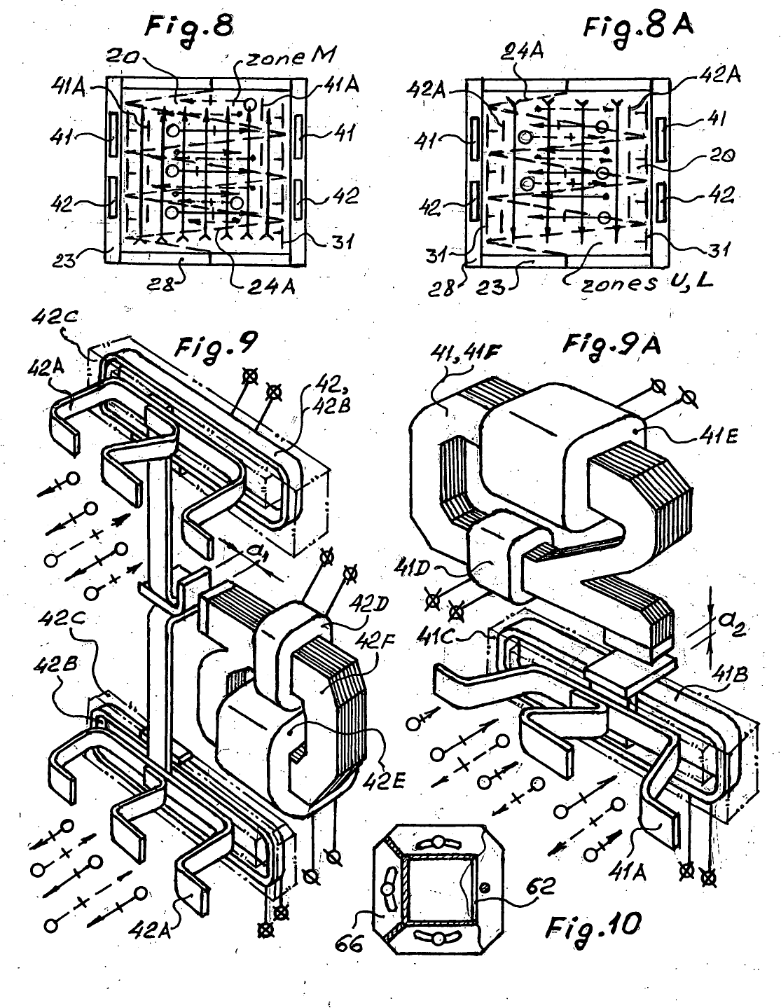

FIGS. 8 and 8A illustrate electromagnetic inductive interactions in any zone M and zones U,L of any base set 20 corresponding to the same instant, respectively. The shown numerals are mentioned above.

FIGS. 9 and 9A illustrate said induced magnetic flux transducers 42 and 41, respectively. In adjacent same-set-side transducers, are shown:
said units 42A,B,C,D,E,F and 41 A,B,C,D,E,F,
air gaps a₁ and a₂,
induced magnetic fluxes in corresponding to shown instant directions.

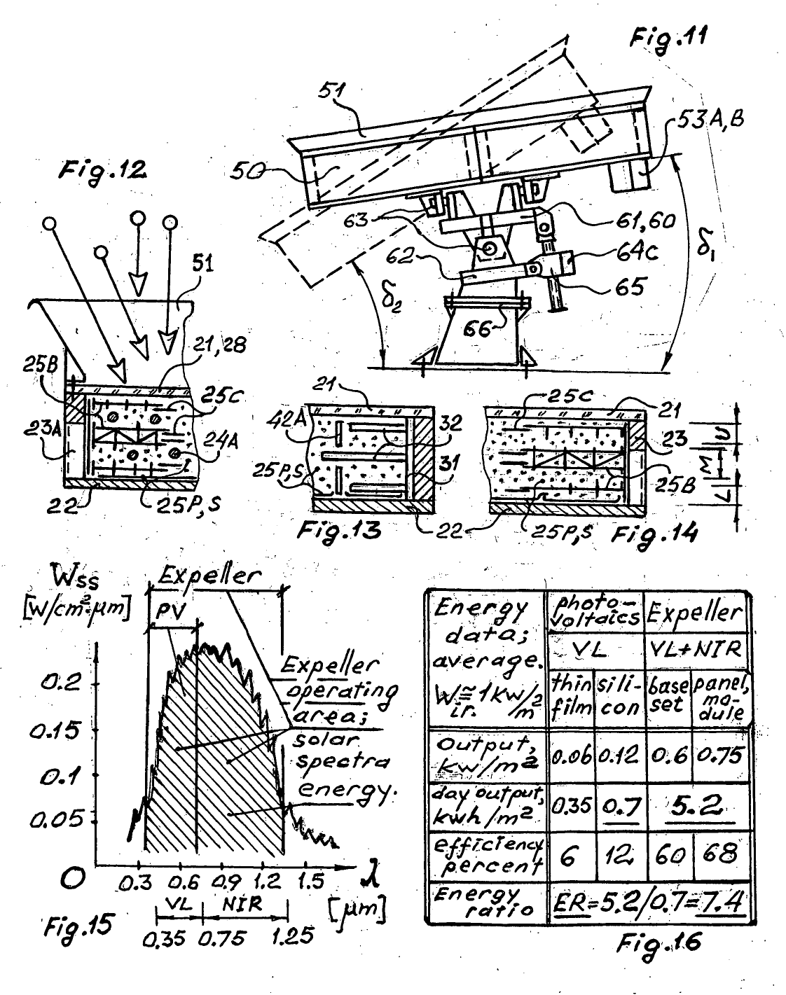

FIGS. 12, 13, 14 show some more detailed interconnections of elements and units said previously in related figures.

FIG. 15 shows the most energy-carrying wave lengths of VL and NIR spectra of solar radiation in Expeller and PV operating areas.

FIG. 16 demonstrates basic energy data of the Expeller in comparison with PV. Are shown the average outputs, efficiencies, and energy ratio.

### Operation

### A. General Considerations.

Electromagnetic waves of incident solar radiation carry energy with the rate of flow described by the Pointing vector. The total instantaneous energy density is the sum of the energy EQUALLY associated with the electric and magnetic fields of said flow. Average Wᵢᵣ=1.0 kw/m².

The Expeller conducts pulse-inductive transfer of said energy flow into electric energy by separate extracting and collecting both electric and magnetic energy—fields of said radiation for output and self-supply portions.

### B. Base Sets 20 and Panel 50.

Exciting inductors 24A fed by oscillators 24 provide needed exciting electromagnetic fields, which are constantly changing in opposite directions. The frequency of said oscillations is tuned corresponding both VL and NIR spectra of treated irradiance.

The shaking electromagnetic induction in any said zones U,M.L is filled up for both refracted in upper screens 21 and reflected from dishes 25S beams of radiation—totally up to 6 times on any beam inside cases 28 of the sets 20. The efficiency of penetrating said beams through the inductors 24A is near 0.9 depending on coil-winding particularities.

The ionizers 25B with needles 25C, fed by their oscillators 25, provide electro-static pulse-ionization inside all said air zones U,M,L. In addition, the electrostatic ionizers 25B constantly attract and repel the grit-powder 25P into powder's oscillated suspended state with tuned frequencies.

The suspended oscillating, electro-statically charged grit-powder 25P contributes to the common levels of combined air ionization in zones U,M,L. The appropriate air ionization provides needed electro-conductivity and permeability for induced electric currents and magnetic fluxes, respectively, and for exciting inducing electromagnetic fluxes as well.

The portions of energy, induced into electric currents from the electric fields of refracted and reflected beams, are collected by non-magnetic electrode structure 31,32 and, after blocks 27 and 30, go to load chain with voltage Vₑ.

The portions of energy induced into magnetic fluxes from the magnetic fields of said beams are accumulated by electromagnetic transducers 41,42 and all their structures 41A,B,C,D,E,F and 42A,B,C,D,E,F. Electric currents, induced in output coils 41E and 42E, after blocks 27 and 40, go to load chain with needed voltage Vₘ.

Some cooling inside the cases of sets 20 may be needed in operations: the windows 23A are controlled by thermostatic servos 64A.

From 4 to 5.5 percent of obtained solar energy go to self-supply for feeding exciting coils, electrostatic ionizers, primary coils of transducers, antenna, solenoids' servos, electric battery charging, various losses.

### C. Module 60; Some Notes.

The said frames elements 61,62,63,64B,C, 65,66 operate in order to provide appropriate orientation for more effective electromagnetic induction of solar radiation inside cases 28 of said sets 20. Shown in FIGS. 4, 11 angles γ, δ_{1,2} change during day light time; they have to provide shown in FIG. 1 angle ζ, equal to 85°±2°taking in account the angles of refraction in upper screen 21.

The frequencies and voltages of exciting and ionizing units are tuned by shown elements of their circuits. The flange unit 66 provides the primary orientation, regarding the real place where the Expeller stands.

The control means of oscillators, solenoid servos, electromagnetic circuits, and regular transformers, relays, diodes, censors, and other obvious elements are not subjects of present proposal and are not shown—for clarity.

The multiple electromagnetic inductions of VL and NIR spectra of incident solar radiation for refracted and reflected beams in said zones U,M,L, with appropriate frequencies of oscillators and angles ζ can provide average efficiency up to 60%, i.e. 0.6 kw/m² and more in further developments.

1. A Solar Irradiance Inductive Expeller for obtaining incident energy of visible light and near infrared spectra, comprises electromagnetic sets each including:
an exciting coil-inductor for magnetic pulse-fluxes inducting, and
electrostatic pulse-ionizers combined with seeding grit-powder for air ionizing in zones of electromagnetic induction, and
electrodes for induced electric currents collecting, and
transducers for induced magnetic fluxes accumulation, and
all said above placed into a common closed case with transparent upper screen and reflecting lower surface, and with cooling windows.

2. The Expeller of claim 1 comprises a method of jolt-inductive treatment for the most energy-carrying spectra of solar radiation wherein said inducting electromagnetic fluxes, and induced electric currents, and induced magnetic fluxes are operatively oscillating in opposite directions inside air ionized zones of said closed cases.

3. The Expeller and method of claims 1,2 wherein said exciting coil-inductor is a loosely reeled-up rectangular winding, which forms inside said case three ionized zones of electromagnetic induction:
an upper zone above said coil, and
a middle zone inside said coil, and
a lower zone under said coil.

4. The Expeller and method of claims 1,2 wherein said exciting coils and ionizers are fed by LC-oscillators tuned to provide needed correspondence of frequencies between electromagnetic exciting and air ionizing in operation, depending on design.

5. The Expeller and method of claims 1,2,3 wherein said inductive operations are provided for both, refracted in upper screen and reflected from lower surface, beams of radiation, and both beams in all of said three air-ionized zones of said cases.

6. The Expeller and method of claims 1,2 wherein said seeding grit-powder is electro-statically operated by pulse-ionizers in order to be in suspended state in all said zones of induction, thus contributing to air electro-conductivity and magnetic permeability, for all volumes where the inducing and induced magnetic fluxes and electric currents act.

7. The Expeller and method of claims 1,2 wherein said induced electric currents collecting electrodes include high-electro-conductive and non-magnetic plates and rods, all placed along opposite walls of said cases.

8. The Expeller and method of claims 1,2 wherein said induced magnetic fluxes transducers are developed multi-coil, with air gaps in cores, and for middle and side zones—separate, and placed along opposite walls of cases.

9. The Expeller and method of claims 1,2 wherein a group of sets forms a panel including a multi-horn receiving antenna tuned for said spectra of radiation; said panel can be arranged with orientation devices forming a tracking model with hinge units, solenoid servos, needed control which corresponds to the sun relative replacement during the day light time.
